(19) United States
(12) Patent Application Publication
(10) Pub. No.: US 2008/0110175 A1
(43) Pub. Date: May 15, 2008

(54) Cowling for connecting a hot gas source to a stirling engine or a turbine

(76) Inventor: Robert G. Graham, Presque Isle, MI (US)

Correspondence Address: MCKELLAR IP LAW, PLLC, 784 SOUTH POSEYVILLE ROAD, MIDLAND, MI, 48640, US

(21) Appl. No.: 11/983,517

(22) Filed: Nov. 10, 2007

Related U.S. Application Data
(60) Provisional application No. 60/858,973, filed on Nov. 14, 2006.
(60) Provisional application No. 60/906,796, filed on Mar. 13, 2007.

(51) Int. Cl. F02C 1/04; F02G 1/00

(52) U.S. Cl. 60/753; 60/517

(57) ABSTRACT

Ceramic cowlings that are used as the connection between a hot gas source and a Stirling engine or a turbine. The ceramic cowling is designed and fabricated with non-dusting, high temperature, dense, low thermal expansion ceramic. It must also be highly resistant to thermal shock. Also, a combination of a ceramic cowling and a shroud for covering and holding the ceramic cowling on a Stirling engine or turbine such that hot gases can flow through the ceramic cowling and into the heat exchanger coil of the Stirling engine and exhaust in a controllable manner. A method of enhancing the power efficiency of a Stirling engine and with systems including the use of at least one enhanced power Stirling engine.

This application claims priority from U.S. Provisional Application No. 60/858,973 filed Nov. 14, 2006 and U.S. Provisional Application No. 60/906,796 filed Mar. 13, 2007.

### FIELD OF THE INVENTION

The present invention relates to a ceramic cowling for connecting a hot gas source to a Stirling engine or a turbine, the use of the cowling while housed in an insulated shroud, and systems that use the ceramic cowling/shroud combination to provide hot gas to a Stirling engine or a turbine to produce electrical power, but also to the provision of alternative sources of energy, such as steam or hot air.

### BACKGROUND OF THE INVENTION

This invention deals with a ceramic cowling that is used as the connection between a hot gas source and a Stirling engine or a turbine. The ceramic cowling is designed and fabricated with non-dusting, high temperature, dense, low thermal expansion ceramic. It must also be highly resistant to thermal shock. This invention also deals with a combination of a ceramic cowling just described Supra, and a shroud for covering and holding the ceramic cowling on a Stirling engine or a turbine such that the hot gases can flow through the ceramic cowling and into the heat exchanger coil of the Stirling engine or the turbine and exhaust in a controllable manner. This invention further deals with a method of enhancing the power efficiency of a Stirling engine or a turbine and with systems including the use of an enhanced power, Stirling engine or turbine.

Stirling engines have been known and used for at least a decade. These engines work by supplying to them a fixed quantity of gaseous working medium that is contained and enclosed within each cylinder of the engine. A portion of the engine is maintained at a constant high temperature by burning any of a wide variety of fuels in the combustor and transferring heat to the gas via heater tubes. The other portion of the engine is maintained at a constant low temperature by circulating the gas through coolers. The working gas is transferred back and forth between the hot and cold portions of the engine and alternately expanded and compressed by the movement of the engine's pistons. The reciprocating motion of the pistons is converted to rotary motion via a swash plate drive which powers the generator. In each cylinder, gas passing through the heater tubes absorbs heat from the combustion and expands, pushing the piston down and thereby doing work in the swash plate. As the piston comes back up, it forces the gas out of the cylinder and through a regenerator, which absorbs heat from the gas passing through it, and stores it temporarily. The gas then passes through the tubes of a cooler and rejects heat to the coolant passing through it. The cooled gas then enters the compression space below the adjacent piston, and as this piston comes down, it is compressed and pushed back up through the regenerator, where it picks up the heat previously stored there, passes through the heater tubes, and the cycle begins again. An example of one such Stirling engine can be fund in U.S. Pat. No. 5,074,114 that issued on Dec. 24, 1991 to Meijer, et al Likewise, the use of turbines to produce energy from syngas has been known for a long time. These engines are mounted to a combustor of some sort that is capable of burning a wide variety of conventional fuels such as natural gas, hydrogen, and propane gas, and to less conventionally used fuels, if they are cleaned, such as scrap wood, forest products and waste, corn and other biomasses to supply the heated gas.

These engines also work well with resource recovery fuels such as flare gas and coal bed methane gas and renewable biogas fuels from landfills or anaerobic digesters such as from sewage or agricultural waste. This results in the conversion of a wide variety of fuels into valuable electrical power and hot water for commercial, industrial and residential applications.

The combustion gas is brought into a cowling or combustion chamber and there is some cooling effect that protects the metal enclosure. A certain amount of heat has to be transferred with a floor of about 1500 dF exit gas temperature. For example, a 55 kw Stirling engine has to transfer 550,000 Btu. At 1650 dF inlet temperature, one would need 6,600 pounds of mass. When one raises the inlet temperature to 2000 dF, one needs only about 4,200 pounds of mass. The pressure drop across the internal heat exchanger coil is 13.2 inches w.c. at 1650 dF, and only 4 inches w.c. at 2000 dF. The higher this mass and pressure drop, the more expensive the capital equipment, that is larger ducts, bigger fans, and increased operating costs, primarily for the fan horsepower to move the mass in and out of the engine.

The limiting factor for temperatures being achieved above 1650 dF, that is, combustion inside the cowling, has been the metal cowling. If one cools the metal with water or air to preserve the cowling, one can drain away essential heat needed to produce power. Much experimentation has been done in bringing clean process flue gas, ranging in temperatures from 1600 dF to 2000 dF, directly into the engine. It was discovered that without exception, even exotic metals failed when the inlet temperature was above about 1600 dF. It should also be noted that one still needs the 1500 dF exit temperature, so that the thermal head is small when the inlet temperature is 1600 dF, and the amount of mass needed to carry 550,000 Btu becomes inordinately high, so one starts reducing power production as inlet air temperature decreases.

A review of Table I will quickly make clear to those skilled in the art why it is a major advantage to be able to increase the temperature to a Stirling engine. At about 1652° F., it is noted, that there is a sharp drop off in engine pressure dropping about three inches w.c. The drop in engine pressure is even more significant as the temperature increases.

TABLE I

| | | | | | | ENGINE | |
|---|---|---|---|---|---|---|---|
| INLET AIR | | AIR MASS | | OUTLET AIR | | PRESSURE | |
| TEMPERATURE | | FLOW | | TEMPERATURE | | DROP | |
| ° C. | ° F. | G/Sec. | Lb/Hr | ° C. | ° F. | kPa | in. wc |
| 800¹ | 1472 | 1000 | 7937 | 677 | 1251 | 3.11 | 12.5 |
| 825² | 1517 | 1000 | 7937 | 699 | 1290 | 3.18 | 12.79 |
| 850³ | 1562 | 1000 | 7937 | 722 | 1332 | 3.25 | 13.07 |
| 875⁴ | 1607 | 1000 | 7937 | 744 | 1371 | 3.32 | 13.35 |
| 900⁵ | 1652 | 1000 | 7937 | 767 | 1413 | 3.39 | 13.63 |
| 925⁵ | 1697 | 855 | 6786 | 770 | 1418 | 2.55 | 10.25 |
| 950⁵ | 1742 | 770 | 6111 | 778 | 1432 | 2.12 | 8.52 |
| 975⁵ | 1787 | 705 | 5595 | 787 | 1449 | 1.82 | 7.32 |
| 1000⁵ | 1832 | 633 | 5024 | 791 | 1456 | 1.50 | 6.03 |
| 1025⁵ | 1877 | 575 | 4566 | 794 | 1462 | 1.26 | 5.07* |
| 1050⁵ | 1922 | 533 | 4229 | 803 | 1478 | 1.10 | 4.42* |
| 1075⁵ | 1967 | 488 | 3872 | 806 | 1483 | 0.94 | 3.78* |
| 1100⁵ | 2012 | 451 | 3576 | 810 | 1490 | 0.80 | 3.22* |

*Calculated
¹= 46 kw
²= 48 kw
³= 51 kw
⁴= 53 kw
⁵= 55 kw

The only materials available that can drive an engine with high temperatures are ceramics. Thus, any type of industrial process that generates a high temperature waste flue gas, that is relatively clean and containing few or no particulates and low acid content, can be sent directly to the engine. If the process generates a medium temperature flue gas, say about 1200 dF, the flue gas can be supplemented with natural gas to raise the flue gas to 2000 dF.

It should be noted that it is at this point that the instant invention differs markedly from the prior art systems. One of the biggest disadvantages of direct-firing a Stirling engine or a turbine with a waste gas flow is that every combustion process, no matter how clean, such as natural gas, has some particulate and some acid. Many, in fact most industrial processes, will have some contaminates. When one adds air for combustion and tempering purposes to a waste combustion gas, one has a flue gas that is high in energy but has no other purpose than to transfer energy. It has to be exhausted after the energy is removed as a contaminated combustion product. This is why Stirling engines and turbines are most popular when one can use both power and, downstream of the engine, a heat recovery device, such as a boiler or hot water heater, for co-generation. The products exiting from the direct-fired Stirling or a turbine in current systems are dirty.

Secondly, the chance for fouling and deterioration are magnified when one uses a process gas, and they are susceptible to upset. For example, if one uses a clean syngas from a wood-fired gasifier and there was a blip that set sent unburned carbon or ash particles directly to the engine, this could completely destroy the heat recovery coil in the engine.

The ceramic cowling and the connecting ductwork to that cowling have to be designed and fabricated with non-dusting, high temperature, dense, low thermal expansion ceramic. It must be highly resistant to thermal shock. Tests have been done using ceramics that can take the temperatures, but they cracked within a matter of hours because they could not handle thermal shock and, in some cases, the ceramic dusted and literally sand blasted the internal of the engine.

The ceramics used in the cowling of this invention are non-dusting, high temperature, dense, low thermal expansion ceramics. Ceramics that are capable of these properties are, for example, Metal Rock 70M from Allied Mineral Products, Inc. Columbus, Ohio, USA and Thermo-Sil® fused silica ceramics from Ceradyne, Inc. Scottdale, Ga., USA. Such materials have bulk densities from about 1.8 to about 2.12 g/cc, compressive strengths of about 27 to 240 MPa (ASTM C-133), linear shrinkage at 1100° C. of zero to about 0.4%, flexural strengths of about 6.9 to 58 MPa, thermal conductivity of abut 0.6 to about 0.8 W/m° C., coefficient of thermal expansion from about 0.5 to about 1.7 10⁻⁶/° C. and a volume percent apparent porosity of from about 7 to about 15 (ASTM C-20).

In summary, one can now fire a Stirling engine or a turbine at higher than normal temperatures with clean, hot air into a ceramic cowling that will take those temperatures, at a reduced mass flow, and lower pressure drop, than can be obtained with even the best combustion process inside a metal cowling to provide enhanced efficiency of the Stirling engine or the turbine.

Another long-term benefit is that an air-fired engine will definitely live longer than a flue gas-fired engine. The ability of the ceramic exchanger to handle corrosive, particulate-laden process gas opens up a plethora of markets, heretofore unavailable. For example, one can now fire coal tailings, poultry litter, and forest products. One can even use hazardous wastes.

In the instant invention, in every case, the indirect-fired Stirling engine or the turbine exits clean, hot air at 1500 dF. This hot air can be returned to the combustion process into either the primary or secondary chamber and used as preheated combustion air. This substantially reduces the amount of fuel need to operate the system. For example, a direct-fired Stirling engine that generates 110 kw would need 1,100 pounds of waste wood per hour. An indirect-fired engine would require only 800 pounds of wood per hour.

A co-generation plant can give one a productive side effect assuming the customer needs steam in the process. Assume the customer wants to fire a conventional boiler with waste wood. The higher the temperature, the more efficient the process, however, slagging at temperatures between 1800 dF and 2200 dF is a real problem. The optimum waste wood-fired boiler would have a flue inlet temperature of about 1600 dF. If one fires a ceramic heat exchanger, as in this invention, at 2200 dF, and drops the flue gas temperature to 1600 dF, and then takes the balance of the heat out with a boiler, one ends up with the best of both worlds. Slagging is no longer a problem, the boiler will have long life, and one can remove heat with the Stirling engine or a turbine at its optimum temperature levels. One can reduce the amount of fuel by providing 100% of the combustion air as preheated air, and the down stream boiler economizer can be sized to drop the stack temperature to between 300 dF and 350 dF.

### THE INVENTION

What is thus described and claimed in this invention is, in one embodiment, is a cowling for connecting a hot gas source to a Stirling engine or a turbine. The cowling has a first portion, a second portion and a third portion that form an integral configuration wherein the first portion is a front, hollow hub of a pre-determined size. The first portion has a front edge and a back end. The second portion is a partial hollow hub having a size larger than the first portion. The second portion has a front end and an open back end and an outside surface. The second portion is integrally attached at the front end with the back end of the first portion such that gas can flow through the first portion into a Stirling engine heat exchanger coil or a turbine, and exit through the second portion.

The third portion is rectangular in shape and has a bottom end and a top edge. The third portion is integrally attached at the bottom end to a portion of the outside surface of the second portion such that gas can exit through the third portion.

There is integrally attached to the back end of the second portion, a fourth portion that is a circular hub wherein the circular hub has a set-off distal edge wherein the set-off distal edge has a flat surface. The set off distal edge has a means for attachment to the support of a Stirling engine or a turbine.

The ceramic cowling has the capability of withstanding high temperatures for prolonged periods of time. By this, it is meant that the ceramic cowling can withstand up to 2400° F. for at least one year. Preferably the duration at the higher temperatures is between 2000° F. and 2200° F. at least two years, and more preferably, the duration at the higher temperatures is at least several months, that is, at least several years.

In another embodiment of this invention, there is in combination, the cowling as set forth just Supra and an insulated shroud that essentially covers the cowling. The shroud has a front, four side walls, and a back. The shroud is fabricated from a metal, and has a first opening through the front for the first portion front edge of the cowling. There is a second opening through one side wall for the top edge of the second portion of the cowling and a third opening in the back to allow the pass through of gas from the second portion of the cowling into a Stirling engine or turbine heat exchanger coil. The shroud has insulation between the cowling and the shroud and the shroud has a means for attaching to a Stirling engine or turbine support structure and a means for attaching the cowling to the shroud.

In yet another embodiment of this invention, there is a method of enhancing the power performance of a Stirling engine or a turbine, the method comprising equipping a Stirling engine or turbine with a cowling and shroud combination as set forth just Supra, and operating the Stirling engine or the turbine with a hot gas temperature in excess of 1652° F.

In still another embodiment of this invention there is a method of powering a Stirling engine or a turbine and providing alternative non-electric power, said Stirling engine or turbine having a heat exchanger coil that has a longitudinal axis.

A further embodiment of this invention is a system for powering a Stirling engine or a turbine, said system comprising in combination a gasifier having a feed mechanism for combustible materials and an ash removal system, a low NOx oxidizer, a metal heat exchanger, a ceramic heat exchanger, at least one Stirling engine, or at lease one turbine and controls for the combination, wherein any Stirling engine or turbine in the combination is fitted with a ceramic cowling in combination with a shroud for the cowling.

Additionally, there is an embodiment of this invention that is a system for providing power and alternative energy, said system comprising in combination a gasifier having a feed mechanism for combustible materials and an ash removal system, a low NOx oxidizer, a metal heat exchanger, a ceramic heat exchanger, at least one Stirling engine or turbine, at least one firetube boiler, and controls for the combination, wherein any Stirling engine or turbine in the combination is fitted with a ceramic cowling in combination with a shroud for the cowling.

### BRIEF DESCRIPTION OF THE DRAWINGS

FIG. 1 is a view in perspective of a ceramic cowling of this invention.

FIG. 2 is a view of a cross section of the ceramic cowling of FIG. 1 through line A-A in a set off from a full side view of a Stirling engine.

FIG. 3 is a full side view of a ceramic cowling and shroud of this invention.

FIG. 4 is a cross sectional view of FIG. 3 through line B-B.

FIG. 5 is a view of FIG. 4 with full side view of a Stirling engines mounted therein.

FIG. 6 is a schematic drawing of a wood fired power plant of this invention utilizing two Stirling engines or two turbines.

FIG. 7 is a schematic drawing of a wood fired power and steam plant utilizing two Stirling engines or two turbines.

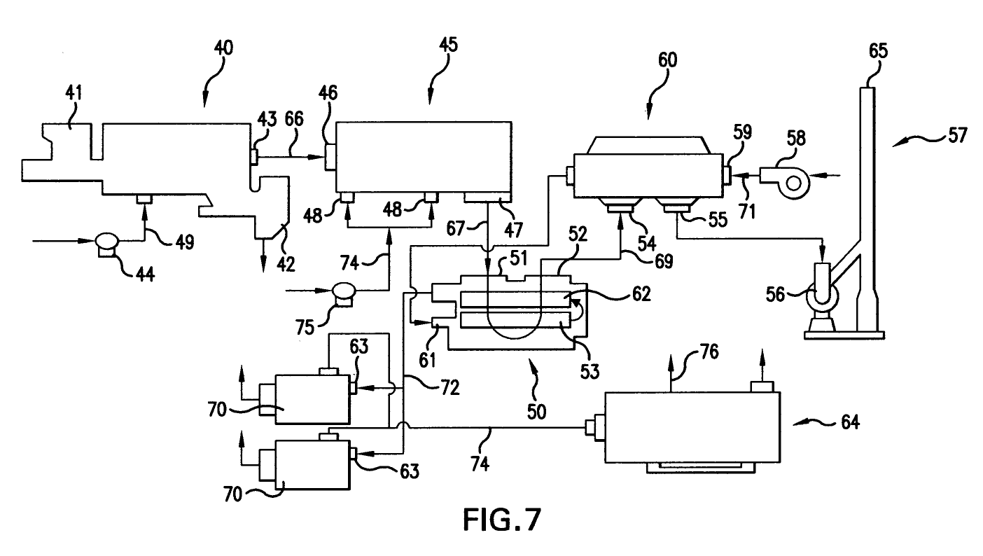

FIG. 8 is a schematic drawing of a system for providing hot air from a Stirling engine or turbine, to a conventional biomass dryer.

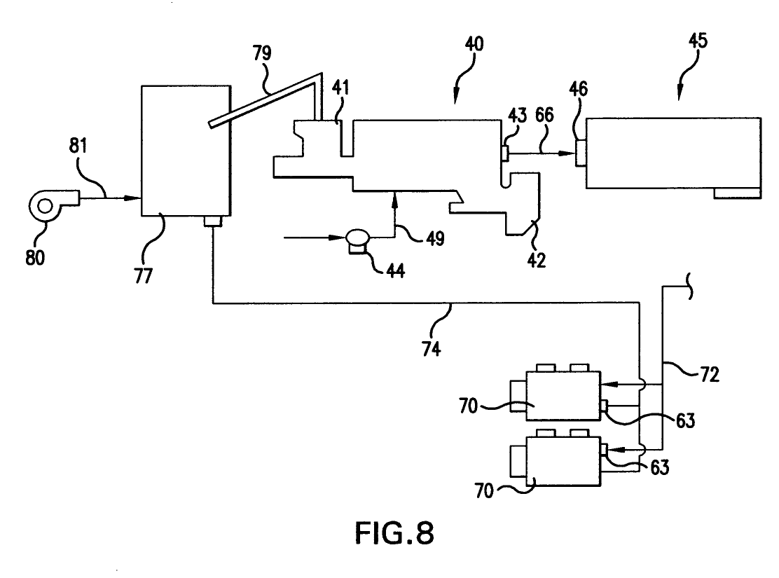

FIG. 9 is a schematic drawing of a system for providing hot air to a wood drying kiln.

### DETAILED DESCRIPTION OF THE INVENTION

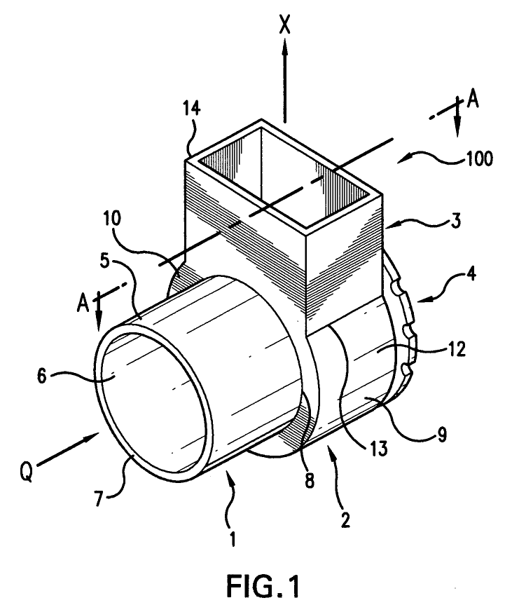

Now, with more specificity, and turning to FIG. 1, there is shown a ceramic cowling 100 of this invention. The ceramic cowling 100 is an integral unit comprised of four portions, that is, a first portion 1 comprising a hollow hub 5 of a pre-determined size. The hollow hub 5 can be any size desired by the user, but it is generally sized according to the size of the heat exchanger coil of the Stirling engine that it is to be used on (Stirling engines are described infra), it being sized such that the front opening 6 of the hub 5 is the same size as the diameter of the heat exchanger coil of the Stirling engine.

The engines of the prior art have the inlet and outlet ducts on the same vertical face, or nearly so, and with heat driven engines with metal cowlings, there was considerable difficulty in insulating the inlet duct and the outlet duct because they were just a few inches apart from each other. The reduced diameter of each duct to fit it in this arrangement, also increased the pressure drop in the engine. The outlet duct had to make a ninety degree turn related to the flow through the engine heat exchanger coil and this meant that the pressure drop across that coil was not uniform and there was a reduction in the coil's heat exchange efficiency. Therefore, the preferred arrangement of the ceramic cowling 100 of this invention is to have the inlet duct (the first portion 1) directly in line with the heat exchanger coil and to have the first portion 1 of the ceramic cowling 100 to be at least as large as the coil of the heat exchanger on the Stirling engine.

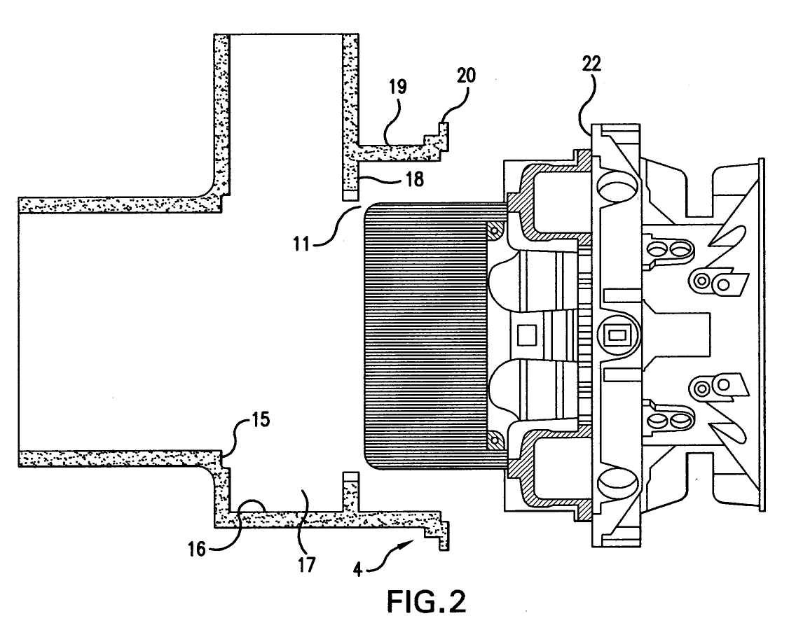

The first portion 1 has a front edge 7 and a back end 8 with a back edge 15 (see FIG. 2), the significance of which is set forth Infra.

The second portion 2 is a partial hollow hub 9 having a circumference size larger than the first portion 1. The reason for a larger circumference than the hub 5 is that this portion of the ceramic cowling 100 is the exhaust part of the ceramic cowling 100. This is also the portion of the ceramic cowling 100 that surrounds the heat exchanger coil of the Stirling engine, and there must be room for the hot gases to exhaust past the heat exchanger of the Stirling engine without severely impeding the flow thereof. The second portion 2 has a front end 10 and an open back end 11 (see FIG. 2) and an outside surface 12. The second portion 2 is integrally attached at the front end 10 to the back end 7 of the first portion 1 such that any hot gas provided to the ceramic cowling 100 can flow through the first portion 1 (indicated by the arrow Q) and into the Stirling engine heat exchanger coil, and exit through the second portion 2 and exit (indicated by arrow X) out of the third portion 3.

Now, the third portion 3 is rectangular in shape and has a bottom end 13 and a top edge 14. The third portion 3 is integrally attached at the bottom end 13 to a portion of the outside surface 12 of the second portion 2. As can be observed from FIGS. 1 and 2, the reason that the bottom end 13 is attached to a portion of the outside surface 12 of the second portion 2 is so that there is a curved inside surface 16 and an open air channel 17 for the expedient exhausting of the hot gases (see FIG. 2).

There is a fourth portion 4 that is integrally attached to the back surface 18 of the second portion 2. This fourth portion 4 is a circular hub 19 that has a set-off distal edge 20. The set-off distal edge 20 has a flat surface 21 that is used for interfacing with a seal (not shown) for the ceramic cowling 100, to the Stirling engine support 22. The ceramic cowling 100 has a means of attachment (in this example, a bolt 23) to the support 22 for the Stirling engine.

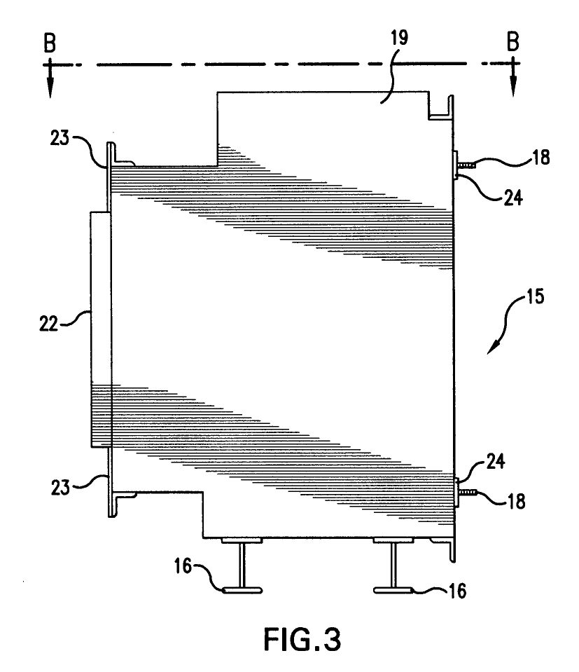

FIG. 3 is a full cross sectional side view of the combination of the ceramic cowling 100, the shroud 15.

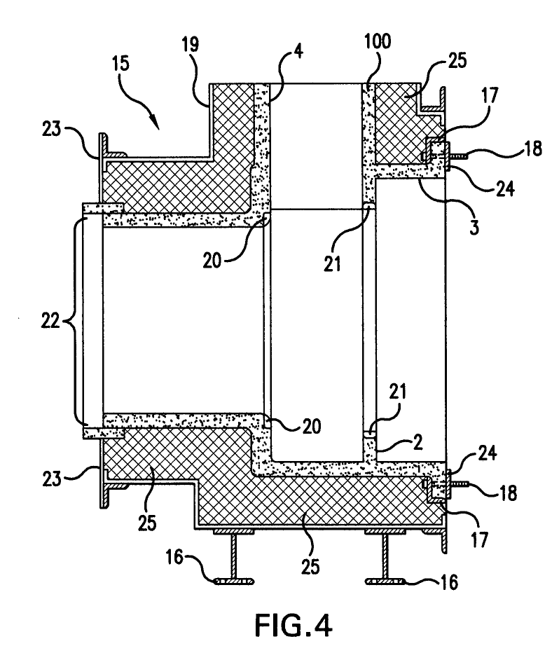

Turning now to FIG. 3, wherein there is shown a full side view of a ceramic cowling 100 and shroud 15 combination of this invention and to FIG. 4, which is a cross sectional view of FIG. 3, there is shown in addition, support saddles 16 for the shroud 15, alloy steel bolt rings 17 for bolts 18, which bolts 18 are used to attach the ceramic cowling 100 to the shroud 15. The bolts 18 are also furnished with gasketing 24. The shroud casing 19 is fabricated from steel and the preferred material is ten gage carbon steel. The metal shell or casing 19 is full seam weld and supports the ceramic cowling 100. The inlet (portion 1) and the outlet (portion 4) connections are gas tight and have gasketed seals. The inlet seal 20 and the outlet seal 21 are between the engine and the inlet and outlet ducts, 1 and 2 respectively. The outlet duct 1 has a very positive pressure and in some cases it could be slightly negative. The inlet duct 1, however, has to have metal outer flange sleeve 22 that bolts up against the mating flange 23 on the steel casing 19. This duct can contain an expansion joint, not shown. There is insulation 25 sandwiched between the steel casing 19 and the ceramic cowling 15.

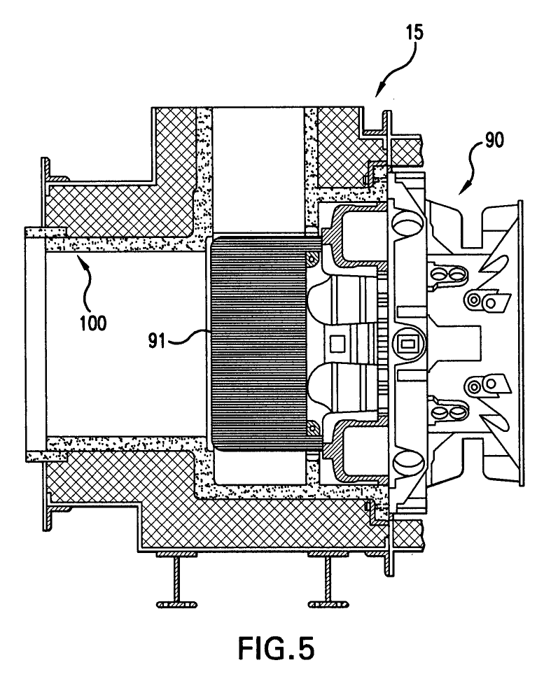

FIG. 5 is a view of a full Stirling engine 90 inserted into the combination of the ceramic cowling 100 and the shroud 15. The heat exchanger coil 91 is also shown to clarify how the engine occupies the combination.

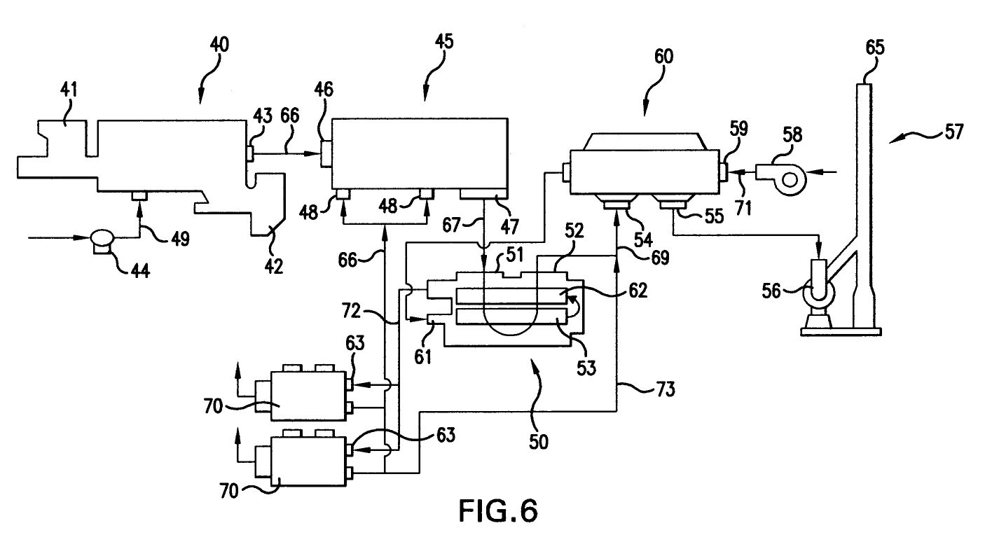

Turning now to FIG. 6, there is shown a schematic of a system of this invention that is a wood fired power plant utilizing two Stirling engines to generate electrical power, in which there is shown a gasifier 40, in this case, a ram feed gasifier, a feed hopper 41 for the biomass, an ash removal system 42, a syngas exit port 43, and an auxiliary air fan 44. The details of the gasifier 40, the low NOx oxidizer 45, the metal heat exchanger 60, the ceramic heat exchanger 50, boilers, and Stirling engines 70, do not need to be defined as such components are conventional and well-known in the art.

The gasifier 40 is fed biomass that is incinerated to produce hot syngas. Ambient air 49 is fed into the gasifier 40 to temper and help burn the biomass. The hot syngas produced by this burning is ducted at about 1150° F. (66) to a low NOx oxidizer 45. The low NOx oxidizer 45 is equipped with a syngas inlet port 46, a syngas outlet port 47, and two additional inlet ports 48 for heated air at 1500° F., 68 from the Stirling engines. The heated gas from the Stirling engines can also be fed to the metal heat exchanger 60 at about 1500° F. at 72. The NOx oxidizer 45 is ducted to the outlet port 43 of the gasifier 40, and is ducted at its outlet end 47 to a ceramic heat exchanger 50. The ceramic heat exchanger 50 has an inlet port 51 for the heated, NOx-free syngas and an outlet port 52. The cleaned syngas is fed (67) to the ceramic heat exchanger 50 at about 2200° F. and moved into the interior of the ceramic heat exchanger 50 and flows around the lower ceramic tubes 53 and the upper ceramic tubes 62 within the heat exchanger 50, and exits 69 at 1600° F. through the outlet port 52 and moves into an alloy metal heat exchanger 60 through an inlet port 54. The alloy metal heat exchanger 60 also has an outlet port 55 that exhausts to an induction draft fan 56 that is interconnected to the stack 57 where exhaust exits 65 the stack 57 at approximately 575° F. to the atmosphere. The alloy metal heat exchanger 60 has an overfire air fan 58 vented into it through an inlet port 59 that brings in ambient air 71.

Turning back to the ceramic heat exchanger 50, it should be noted that heated outside air from the alloy metal heat exchanger 60 is passed through the metal heat exchanger 60 and ducted into the ceramic heat exchanger 50 through inlet port 61, and that this air is moved through the ceramic tubes 53 and is thereby heated by the heated syngas. The heated air travels through the lower set of ceramic tubes 53, into the upper set of ceramic tubes 62, and out of the ceramic heat exchanger 50 and about 1800° F. (72) and into the double set of Stirling engines 70 through an air inlet 63 in each such engine. The heated air moves through the Stirling engines 70, powering them.

In another embodiment of this invention, the preheated combustion air from the Stirling engines 70 is moved 74 at about 1500° F. to a firetube boiler 64 to provide saturated steam 76 (FIG. 6). It should also be noted in FIG. 6, which is a schematic of a system in which the Stirling engines feed directly into a firetube boiler 64, that the hot gas 66 from the Stirling engines do not feed into the oxidizer 45 and instead, the oxidizer is fed ambient air 74 from a fan 75.

There are typically five arrangements that can be configured from using hot air from a ceramic heat exchanger 50 to drive Stirling engines 70 and wherein the heated air from the Stirling engines can be used in energy production as an alternative to electrical energy provided by the Stirling engines.

Such heated air from Stirling engines has to be processed indirectly, such as sending it to a waste heat boiler as described just Supra.

A first arrangement would be where the air is returned to the combusters, such as the gasifier 40 or the oxidizer 45, as preheated combustion air, such as is shown in FIG. 6. This substantially reduces the amount of fuel required.

In a second arrangement, the heated air is mixed with the flue gas between the ceramic heat exchanger 50 and the metal heat exchanger 60 as shown in FIG. 6. This reduces the size of the metal heat exchanger 60 because one has a higher flue gas mass to transfer heat.

A third arrangement is where there is a need for steam or hot water, the heated air can be sent to the boiler or water heater as combustion air for the auxiliary natural gas and/or oil fired burner as shown in FIG. 6. The end user of the system normally requires turndown or peaking of these heat recovery units. Solid waster-fired systems do not have a large turndown ratio or the ability to respond readily to steam or water demands. The auxiliary burner can supply peak energy rapidly and use the engine hot air exhaust as preheated combustions air. The auxiliary burner also assists in start-up and shutdown, and is a heat source if the solid waste train is down for maintenance.

In a fourth arrangement, one of the best waste fuels is wet forest products. Most waste products' moisture can range as high as 60%, since it is bark, small limbs, and leaves. When one gets to about 52% moisture, one doesn't have sufficient energy available to reach a high enough entrance temperature to the ceramic heat exchanger to transfer heat to the engine air. When the forest products are in the 20% range, that is kiln dried, to 45%, that is, air dried surface moisture range, the gasifiers and oxidizers work very well. Pre-drying of the fuel makes firing of high moisture material practical.

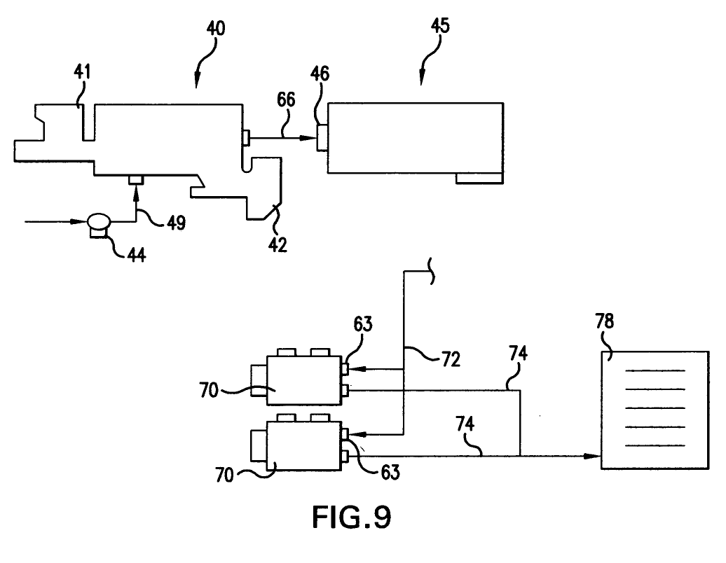

Most of the forest products in the logging industry are in the 59% range and they need power so the engine air 74 can be sent to a conventional rotary or conveyor dryer 77 located between the storage and the feed hopper 41, and then conveyed by a rotary conveyor 79 to the feed hopper 41. The high temperature air would be mixed with ambient air 81 from a fan 80, and in turn would mix directly with the biomass to reduce the moisture content down to the 35% to 40% range. Partially drying wood with hot air gives one a non-polluting affluent. This is shown in FIG. 9.

With regard to arrangement five, there are industries that need clean hot air for particular processes. For example, lumber mills require humidity controlled hot air to dry wood. The engine air 74 can be sent directly to a wood drying kiln 78 where it is mixed with humid air being recirculated, with a portion exhausted to the atmosphere. This is shown in FIG. 9.

Also contemplated within the scope of this invention is the use of a turbine in place of a Stirling engine, or the use in combination with a Stirling engine, either singly, or in multiple units of either a Stirling engine or a turbine.

Turbines, as used herein, means any conventional turbine. These have been defined as a machine for generating rotary mechanical power from the energy in a stream of fluid supplied to the turbine. “Fluid” as used herein means those fluids most commonly used in turbines such as steam, hot air, or combustion products and water. Steam raised in fossil fuel fired boilers or nuclear reactor systems is widely used in turbines for electrical power generation, ship propulsion, and mechanical drives. The combustion gas turbine has these applications in addition to important uses in aircraft propulsion. Water turbines are used for electrical power generation.

Energy, originally in the form of head or pressure energy, is converted to velocity energy by passing through a system of stationary and moving blades in the turbine. Changes in the magnitude and direction of the fluid velocity are made to cause tangential forces on the rotating blades, producing mechanical power via turning rotors. Turbines effect the conversion of fluid to mechanical energy through the principles of impulse, reaction, or a mixture of the two.

What is claimed is:

1. A ceramic cowling for connecting a hot gas source to a Stirling engine or a turbine, said ceramic cowling having a first portion, a second portion and a third portion that form an integral configuration wherein the first portion is a front, hollow hub of a pre-determined size, said first portion having a front edge and a back end with a back edge; the second portion is a partial hollow hub having a size larger than the first portion, said second portion having a front end and an open back end and an outside surface, said second portion being integrally attached at the front end with the back end of the first portion; such that gas can flow through the first portion into a Stirling engine or turbine heat exchanger coil and exit through the second portion; said third portion being rectangular in shape and having a bottom end and a top edge, said third portion being integrally attached at the bottom end to a portion of the outside surface of the second portion, such that the gas can exit through the third portion, there being integrally attached to the back end of the second portion a fourth portion that is a circular hub, said circular hub having a set-off distal edge wherein the set-off distal edge has a flat surface, said set off distal edge having a means for attachment to the support of a Stirling engine or a turbine, wherein the ceramic cowling can withstand high temperatures for a prolonged period of time.

2. A cowling as claimed in claim 1 wherein the set-off distal edge of the fourth portion has holes or notches for the insertion of bolts.

3. A cowling as claimed in claim 1 wherein the set-off distal edge of the fourth portion has bolts molded into the set-off distal edge.

4. A cowling as claimed in claim 1 wherein the set-off distal edge of the fourth portion has a heat resistant gasket ring that interfaces with the flat surface of the set-off distal edge.

5. A cowling as claimed in claim 1 that is non-dusting.

6. A cowling as claimed in claim 1 that is resistant to thermal shock at temperatures of from 1650° F. and up to 2400° F.

7. A cowling as claimed in claim 1 that has low expansion characteristics under the application of heat.

8. In combination, the cowling as claimed in claim 1 and an insulated shroud that essentially covers the cowling, said shroud having a front, four side walls, and a back, said shroud being fabricated from a metal, said shroud having a first opening through the front for the first portion front edge of the cowling, a second opening through one side wall for the top edge of the second portion of the cowling, a third opening in the back to allow the pass through of gas from the first portion of the cowling into a Stirling engine heat exchanger coil; said shroud having insulation between the cowling and the shroud; said shroud having a means for attaching to a Stirling engine support structure and a means for attaching the cowling to the shroud, wherein the ceramic cowling can withstand high temperatures for a prolonged period of time.

9. The combination as claimed in claim 8 wherein, in addition, there is a seal between the first portion back edge and the heat exchanger coil of the Stirling engine.

10. A method of enhancing the power performance of a Stirling engine, said method comprising:
(I) equipping a Stirling engine with a cowling and shroud combination as claimed in claim 8;
(II) operating the Stirling engine with a hot gas temperature in excess of 1652° F.

11. A method as claimed in claim 10 wherein the temperature is in excess of 1742° F.

12. A method as claimed in claim 10 wherein the temperature is in excess of 1787° F.

13. A method as claimed in claim 10 wherein the temperature is in excess of 1832° F.

14. A method of powering a Stirling engine having a heat exchanger coil that has a longitudinal axis, said method enhancing the power performance of the Stirling Engine, said method comprising:
(A) providing a source of hot gas in excess of 1652° F.,
(B) conveying said hot gas under pressure to a combination of cowling and shroud as claimed in claim 8 that is attached to the Stirling engine;
(C) allowing the gas to flow into and out of the heat exchanger coil of the Stirling engine whereby the Stirling engine is powered, wherein the cowling is positioned directly in front of the heat exchanger coil along the longitudinal axis and the diameter of the cowling is at least as large as the diameter of the heat exchanger coil, and wherein the ceramic cowling can withstand high temperatures for a prolonged period of time.

15. A method of powering a Stirling engine having a heat exchanger coil that has a longitudinal axis, and providing alternative non-electric power, said method comprising:
(A) providing a source of hot gas in excess of 1652° F.,
(B) conveying said hot gas under pressure to a combination of cowling and shroud as claimed in claim 8 that is attached to the Stirling engine;
(C) allowing the gas to flow into and out of the heat exchanger coil of the Stirling engine whereby the Stirling engine is powered, wherein the cowling is positioned directly in front of the heat exchanger coil along the longitudinal axis and the diameter of the cowling is at least as large as the diameter of the heat exchanger coil, and wherein the ceramic cowling can withstand high temperatures for a prolonged period of time.

16. A method of enhancing the power performance of a Stirling engine, the method comprising equipping a Stirling engine with a cowling and shroud combination as set forth in claim 8 and operating the Stirling engine with a hot gas temperature in excess of 1652° F.

17. A system for powering a Stirling engine, said system comprising in combination a gasifier having a feed mechanism for combustible materials and an ash removal system, a low NOx oxidizer, a metal heat exchanger, a ceramic heat exchanger, at least one Stirling engine, and controls for the combination, wherein any Stirling engine in the combination is fitted with a ceramic cowling in combination with a shroud for the cowling, wherein the ceramic cowling can withstand high temperatures for a prolonged period of time.

18. A system for providing power and alternative energy, said system comprising in combination a gasifier having a feed mechanism for combustible materials and an ash removal system, a low NOx oxidizer, a metal heat exchanger, a ceramic heat exchanger, at least one Stirling engine, at least one auxiliary recipient for non-electric power, and controls for the combination, wherein any Stirling engine in the combination is fitted with a ceramic cowling in combination with a shroud for the cowling, wherein the ceramic cowling can withstand high temperatures for a prolonged period of time.

19. A system as claimed in claim 18 wherein the auxiliary recipient for non-electric power if a fire tube boiler.

20. A system as claimed in claim 18 wherein the auxiliary recipient for non-electric power is a drying kiln for wood products.

21. A system as claimed in claim 18 wherein the auxiliary recipient for non-electric power is a dryer for waste forest products.

22. A system as claimed in claim 18 wherein the auxiliary recipient for non-electric power is a low NOx oxidizer.

23. A system as claimed in claim 18 wherein the auxiliary recipient for non-electric power is a heat exchanger.

24. A system as claimed in claim 18 wherein the auxiliary recipient for non-electric power is a steam plant.

25. A method of enhancing the power performance of a turbine, said method comprising:
(I) equipping a turbine with a cowling and shroud combination as claimed in claim 8;
(II) operating the turbine with a hot gas temperature in excess of 1652° F.

26. A system for powering a turbine, said system comprising in combination a gasifier having a feed mechanism for combustible materials and an ash removal system, a low NOx oxidizer, a metal heat exchanger, a ceramic heat exchanger, at least one turbine, and controls for the combination, wherein any turbine in the combination is fitted with a ceramic cowling in combination with a shroud for the cowling, wherein the ceramic cowling can withstand high temperatures for a prolonged period of time.

27. A system for providing power and alternative energy, said system comprising in combination a gasifier having a feed mechanism for combustible materials and an ash removal system, a low NOx oxidizer, a metal heat exchanger, a ceramic heat exchanger, at least one turbine, at least one auxiliary recipient for non-electric power, and controls for the combination, wherein any turbine engine in the combination is fitted with a ceramic cowling in combination with a shroud for the cowling, wherein the ceramic cowling can withstand high temperatures for a prolonged period of time.
